(19) United States
(12) Patent Application Publication
(10) Pub. No.: US 2025/0196378 A1
(43) Pub. Date: Jun. 19, 2025

(54) Quick-change Blade Structure

(71) Applicant: Chen Zhiming, Yangjiang (CN)

(72) Inventor: Chen Zhiming, Yangjiang (CN)

(21) Appl. No.: 18/544,432

(22) Filed: Dec. 19, 2023

(30) Foreign Application Priority Data
Nov. 30, 2023 (CN) 2023232573251

(51) Int. Cl. B26B 5/00

(52) U.S. Cl. CPC B26B 5/00

(57) ABSTRACT

A quick-change blade structure comprises a blade, a fixed seat, a locking device, and a resilient component. The fixed seat is equipped with a guide groove for inserting the blade. The blade features a locking groove, and the locking device is rotatably mounted on the fixed seat. One end of the locking device has a protruding locking head, while the other end has a pressing part connected to the resilient component. The elastic force of the resilient component presses the locking head into the locking groove, securing the blade. Pressing the part allows the locking device to rotate, releasing the locking head from the locking groove for blade removal.

Installing the blade involves, inserting it directly along the guide groove into the fixed seat. The locking head of the locking device automatically presses onto the locking groove under the action of the resilient component, achieving blade installation. To replace the blade, simply press the part on the locking device, disengaging the locking head from the locking groove, allowing the blade to be pulled out, thereby achieving quick blade replacement. The structure is characterized by its simple and convenient operation and high efficiency.

### TECHNICAL FIELD

This utility model relates to the field of blade technology, particularly a quick-change blade structure.

### BACKGROUND TECHNOLOGY

Due to their sharp blades, affordable prices, and compact designs, utility knives are widely used in various industries such as crafts, decoration, printing, and advertising. Currently, most utility knives adopt a replaceable blade structure. When the blade becomes dull, users need to open the cover, remove the old blade, insert a new one, and then close the cover. This process is cumbersome and inefficient. Therefore, there is an urgent need for a structure that enables the quick replacement of blades to overcome the deficiencies in existing technology products.

### PRACTICAL NOVELTY CONTENT

To address the above technical issues, the utility model provides a quick-change blade structure that enables the fast replacement of blades, offering a simple and convenient operation with high blade replacement efficiency.

To achieve this purpose, the technical solution adopted in this utility model is a quick-change blade structure, comprising a blade, a fixed seat, a locking device, and an resilient component. The fixed seat has a guide groove, into which the blade is inserted, and the blade has a locking groove. The locking device is rotatably installed on the fixed seat, with one end having a raised locking head, and the other end having a pressing part. The pressing part is connected to the resilient component, and the resilient force of the resilient component presses the locking head into the locking groove, thereby securing the blade. When the pressing part is pressed, the locking device rotates, allowing the locking head to disengage from the locking groove, facilitating the blade's removal.

As a further improvement to this utility model, the guide groove includes upper and lower guide bars and a rear-limiting plate. The spacing between the upper and lower guide bars is matched to the width of the blade, allowing the blade to move only along the guide groove, and the position of the locking head corresponds to the locking groove when the blade reaches the limiting plate.

As a further improvement to this utility model, the locking device is a bar-shaped structure, with its central part hinged on the fixed seat. The locking head is located on the front bottom side of the locking device, and the pressing part is positioned at the rear end of the locking device, with the resilient component connected to the bottom side of the pressing part.

As a further improvement to this utility model, a pivot is installed on the fixed seat, and a pivot hole is provided on the locking device. The locking device is rotatably mounted by engaging the pivot hole with the pivot.

As an additional improvement to this utility model, the resilient component is a V-shaped spring. The fixed seat has a spring groove, and the V-shaped spring is installed in the spring groove. One end of the V-shaped spring is fixed, while the other end is movably set and presses against the pressing part.

As a further improvement to this utility model, the fixed seat includes a left fixed plate and a right fixed plate. The right fixed plate has a clamping groove, and the left fixed plate is clamped onto the right fixed plate through the clamping groove and is secured by screws.

As an additional improvement to this utility model, the fixed seat has a downwardly recessed pressing port, where the pressing part is located within the pressing port.

As a further improvement to this utility model, the blade is of a left-right symmetrical structure, and two symmetrically positioned locking grooves are provided on the blade.

As an additional improvement to this utility model, it further includes an arc-shaped spring piece. The arc-shaped spring piece is installed in the guide groove and applies elastic force to press against the blade.

The advantageous effect of this utility model is that it is equipped with a locking device. When installing the blade, the blade is directly inserted into the fixed seat along the guide groove. The locking head of the locking device is automatically pressed onto the locking groove of the blade under the action of the elastic component, thereby achieving blade installation. When it is necessary to replace the blade, simply press the pressing part on the locking device, disengaging the locking head from the locking groove, allowing the blade to be quickly removed. This design has the characteristics of simple and convenient operation and high efficiency.

### ILLUSTRATION DESCRIPTION

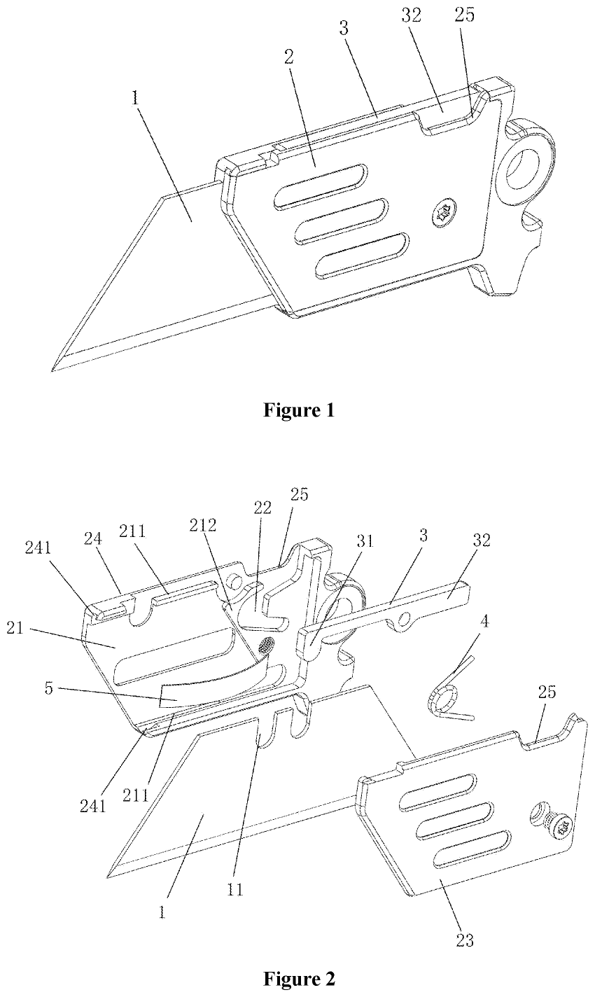

FIG. 1 depicts a schematic diagram of the overall structure of the present utility model;

FIG. 2 shows an exploded structural schematic diagram of the present utility model;

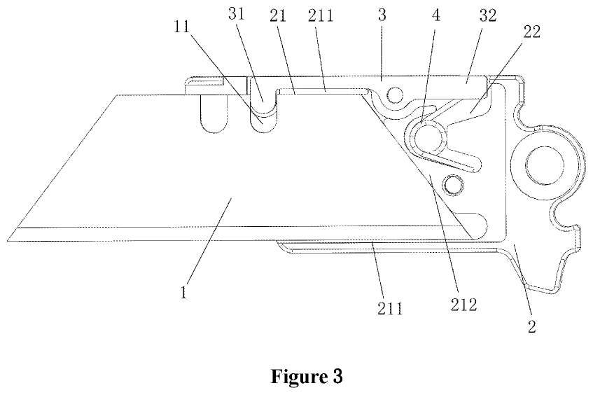

FIG. 3 illustrates a schematic diagram of the internal structure of the present utility model.

Explanation of Symbols: Blade 1, Locking groove 11, Fixed seat 2, Guide groove 21, Guide bar 211, Limiting plate 212, Spring groove 22, Left fixed plate 23, Right fixed plate 24, Clamping groove 241, Pressing port 25, Locking device 3, Locking head 31, Pressing part 32, V-shaped spring 4, Arc-shaped spring piece 5.

### DETAILED IMPLEMENTATION

As shown in FIGS. 1-3, a quick-change blade structure comprises a blade 1, a fixed seat 2, a locking device 3, a resilient component, and an arc-shaped spring piece 5. The fixed seat 2 is provided with a guide groove 21 with one side open, and the blade 1 is inserted into the fixed seat 2 along the guide groove 21. The top side of the blade 1 is provided with a downwardly recessed locking groove 11. The locking device 3 adopts a strip structure, and the middle part of the locking device 3 is provided with a pivot hole. The inner wall of the fixed seat 2 is equipped with a pivot, and the locking device 3 can be rotatably mounted on the fixed seat 2 through the cooperation of the pivot hole and pivot. The front bottom side of the locking device 3 is provided with a downwardly protruding locking head 31, and the rear end is equipped with a pressing part 32. The bottom side of the pressing part 32 is connected to the resilient component. The resilient component adopts a V-shaped spring 4, and the fixed seat 2 is provided with a spring groove 22. The V-shaped spring 4 is installed in the spring groove 22, with one end fixed and the other end movably set and pressed against the pressing part 32.

When installing the blade 1, insert it along the guide groove 21 into the fixed seat 2. The elastic force of the V-shaped spring 4 can automatically lift the pressing part 32 of the locking device 3 upward, causing the locking head 31 of the locking device 3 to press downward. When the blade 1 moves to a position corresponding to the locking groove 11 and the locking head 31, the locking head 31 moves downward, pressing into the locking groove 11, restricting the movement of the blade 1, thereby achieving the secure installation of the blade 1. To replace the blade 1, simply press the pressing part 32 of the locking device 3. The V-shaped spring 4 is compressed, causing the locking head 31 to move upward and disengage from the locking groove 11, allowing the blade 1 to be pulled out, achieving quick blade replacement.

In this embodiment, the fixed seat 2 consists of the left fixed plate 23 and the right fixed plate 24. The right fixed plate 24 has a clamping groove 241, and the left fixed plate 23 is clamped on the right fixed plate 24 and fixed with screws. This structure facilitates the installation and disassembly of the fixed seat 2.

The guide groove 21 of the fixed seat 2 is composed of guide bars 211 set on the upper and lower sides and a limiting plate 212 set on the rear side. The spacing between the upper and lower guide bars 211 is matched with the width of the blade 1, allowing the blade 1 to move only along the guide groove 21. The limiting plate 212 is used to limit the movement of the blade 1. When the blade 1 moves to the position of the limiting plate 212, the locking head 31 of the locking device 3 corresponds to the locking groove 11 of the blade 1.

To facilitate the user to push the pressing part 32 of the locking device 3, a downwardly concave pressing port 25 is set on the fixed seat 2, and the pressing part 32 is located in the pressing port 25.

The blade 1 adopts a left-right symmetric isosceles trapezoidal structure, with two symmetrically positioned locking grooves 11. This structure allows either side of the blade 1 to be installed on the fixed seat 2, enabling the use of both sides of the blade 1. When one side of the blade 1 becomes dull, it can be pulled out and replaced with the other side, improving the utilization of the blade 1.

The arc-shaped spring piece 5 is installed on the side wall of the guide groove 21, providing downward pressure on the blade 1 to increase the friction when the blade 1 moves forward and backward. This structure prevents the blade 1 from directly falling off when accidentally push the pressing part 32 of the locking device 3, requiring external force to pull out the blade 1, thereby preventing accidental detachment and enhancing safety.

The above-mentioned embodiments are presented solely for illustrative purposes to enhance the understanding of the present utility model. They do not impose any form of limitation on the utility model. Individuals with ordinary skills in the relevant technical field, within the scope of the technical features disclosed by the utility model, have the flexibility to make local modifications or adjustments to the disclosed technical content without deviating from the technical features of the utility model. Such equivalent embodiments, which remain within the technical features of the utility model, are still encompassed by the technical features of the utility model.

1. A quick-change blade structure, characterized by the inclusion of a blade, a fixed seat, a locking device, and a resilient component. The fixed seat is equipped with a guide groove into which the blade is inserted. The blade features a locking groove, and the locking device is rotatably mounted on the fixed seat. One end of the locking device has a protruding locking head, while the other end has a pressing part. The pressing part is connected to the resilient component, and the elastic force of the resilient component presses the locking head into the locking groove, securing the blade. Pressing the pressing part causes the locking device to rotate, releasing the locking head from the locking groove for blade removal.

2. According to claim 1 of the quick-change blade structure, it is characterized by: the guide groove includes guide bars set on the upper and lower sides and a limiting plate set on the rear side. The spacing between the upper and lower guide bars is adapted to the width of the blade, allowing the blade to move only along the guide groove. When the blade moves to the position of the limiting plate, the locking head corresponds to the locking groove position.

3. According to claim 1 of the quick-change blade structure, it is characterized by: the locking device is a strip-shaped structure, and the middle part of the locking device is hinged on the fixed seat. The locking head is set on the front bottom side of the locking device, and the pressing part is set on the rear end of the locking device. The resilient component is connected to the bottom side of the pressing part.

4. According to claim 1 of the quick-change blade structure, it is characterized by: the fixed seat is equipped with a pivot, and the locking device has a pivot hole. The locking device is rotatably installed by the cooperation of the pivot hole and the pivot.

5. According to claim 1 of the quick-change blade structure, it is characterized by: the resilient component is a V-shaped spring, and the fixed seat is equipped with a spring groove where the V-shaped spring is installed. One end of the V-shaped spring is fixed, while the other end is movably set and connected to the pressing part, applying top pressure.

6. According to claim 1 of the quick-change blade structure, it is characterized by: the fixed seat comprises a left fixed plate and a right fixed plate. The right fixed plate has a connecting groove, and the left fixed plate is connected to the right fixed plate through the connecting groove and secured by screws.

7. According to claim 1 of the quick-change blade structure, it is characterized by: the fixed seat has a downwardly concave pressing port, and the pressing part is located within the pressing port.

8. According to claim 1 of the quick-change blade structure, it is characterized by: the blade has a symmetrical structure, featuring two symmetrically positioned locking grooves.

9. According to claim 1 of the quick-change blade structure, it is characterized by: additionally incorporating an arc-shaped spring plate, which is installed in the guide groove to provide elastic force for top pressure on the blade.
